(19) United States
(12) Patent Application Publication
(10) Pub. No.: US 2007/0046566 A1
(43) Pub. Date: Mar. 1, 2007

(54) Collision electrification particle, electronic paper display device using the same and manufacturing method thereof

(75) Inventor: Moon Bong Song, Seoul (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/509,644

(22) Filed: Aug. 25, 2006

(30) Foreign Application Priority Data
Aug. 26, 2005 (KR) 10-2005-0078785

(51) Int. Cl. G03G 9/00; G09G 3/00

(52) U.S. Cl. 345/30; 430/108.3

(57) ABSTRACT

A collision electrification particle, an electronic paper display device using the same and a manufacturing method thereof are disclosed. An electrified particle stabilizing agent is coated at the outside of polymer resin in a spherical shape. As a result, only an electrified particle stabilizing agent is used without an additional electric charge controlling agent. Consequently, it is possible to easily manufacture the electronic paper display device. Furthermore, it is possible to finely control the polarity of the particle by controlling the amount and the electrification magnitude of the particle stabilizing agent.

This application claims the benefit of Korean Patent Application No. 10-2005-0078785, filed on Aug. 26, 2005, which is hereby incorporated by reference as if fully set forth herein.

### BACKGROUND OF THE INVENTION

1. Field of the Invention

The present invention relates to a collision electrification particle, an electronic paper display device using the same and a manufacturing method thereof.

2. Discussion of the Related Art

An electronic paper display device is a core device to realize a flexible display. The electronic paper display device is based on electrophoresis in which an electromagnetic field is applied to a conductive material such that the conductive material has mobility. Micro particles having conductivity are distributed between thin-type flexible substrates, and positions of the micro particles (or toner particles) are changed due to the change of the polarities of an electromagnetic field, whereby data is displayed.

The technical approach to realize the electronic paper may be accomplished using liquid crystals, organic electro luminescence (EL), reflective film reflection-type display, electrophoresis, twist balls, or mechanical reflection-type display. Among them, an electronic paper display device using electrophoresis is the most notable technology at the present time. The electrophoresis is a phenomenon in which, when particles are suspended in a medium (a dispersion medium), the particles are electrically charged, and, when an electric field is applied to the charged particles, the particles move to an electrode having opposite charge through the dispersion medium.

FIG. 1 is a sectional view illustrating a cell structure of a general collision electrification electronic paper display device. As shown in FIG. 1, the collision electrification electronic paper display device includes upper and lower substrates 40 and 30, which are made of plastic or glass, upper and lower electrodes 10 and 20 formed on the upper and lower substrates 40 and 30 to apply driving voltage to the upper and lower substrates, the upper and lower electrodes 10 and 20 being made of a transparent material, barrier ribs to uniformly maintain the distance between the upper and lower substrates 40 and 30 and to isolate cells from each other, and white (−) electrification particles 60 and black (+) electrification particles 50 located between the upper and lower electrodes.

In the collision electrification electronic paper display device with the above-stated construction, when sufficient voltage is applied to the upper electrodes 10 and the lower electrodes 20, electrification particles electrified according to the polarities of the electrodes, to which the voltage is applied, move to the corresponding electrodes. For example, when the white electrification particles 60 have (−) polarity, whereas the black electrification particles 50 have (+) polarity, and (+) voltage is applied to the upper electrodes 10, whereas (−) voltage is applied to the lower electrodes 20, the white electrification particles 60 move to the upper electrodes 10, whereas the black electrification particles 50 move to the lower electrodes 20. As a result, white color is displayed. When (−) voltage is applied to the upper electrodes 10, on the other hand, the black electrification particles 50 move to the upper electrodes 10. As a result, black color is displayed.

In the collision electrification electronic paper display device, two particles having different colors in each cell are rubbed with each other. As a result, one of the two particles is electrified with a positive charge (+), whereas the other particle is electrified with a negative charge (−). The magnitude of the electrification amount and the polarity of the particles are mainly controlled by the amount and kind of an electric charge controlling agent added in polymer particles at the time of manufacturing the polymer particles. FIG. 2 is a typical view of a particle used in the conventional collision electrification electronic paper display device, illustrating an electric charge controlling agent 4 contained in electrophoretic polymer resin 2. Furthermore, an outer additive agent, i.e., a particle stabilizing agent 1, and a pigment or a dye 3, which displays color of the particle, may be further contained in the polymer resin 2 in order to increase the mobility of the particle.

As shown in FIG. 2, the particle stabilizing agent 1, such as resin, silicon resin, or an coupling agent, is physically coated on the outer surface of the polymer resin 2, which contains the electric charge controlling agent 4 and the pigment or the dye 3. When the outer additive agent exists at the surface of the particle in bundles, the outer additive agent may be easily separated from the polymer resin. In the case that the outer additive agent is easily separated from the polymer resin, the electrification particle cannot sufficiently respond to the same applied voltage, and the electrification characteristics are also easily changed. As a result, the quality of pictures is deteriorated. Furthermore, the uniformity of pictures is lowered, and therefore, the service life of products is reduced.

Also, in the particle used in the general collision electrification electronic paper display device, as shown in FIG. 2, the electric charge controlling agent is located in the particle as well as at the surface of the particle. Even though the electric charge controlling agent is located at the surface of the particle, the electric charge controlling agent exists in bundles. Actually, the electrification amount of the particle is controlled only by the amount of the electric charge controlling agent existing at the surface of the particle. However, the electric charge controlling agent also exists in the particle. As a result, the added electric charge controlling agent and the magnitude of the electrification amount are not proportional to each other, and therefore, it is very difficult to control the electrification amount.

As described above, in the particle used in the general collision electrification electronic paper display device, the electric charge controlling agent and the particle stabilizing agent exist in the particle as well as at the surface of the particle. As a result, unbalance occurs between the electric charge controlling agent and the particle stabilizing agent. Furthermore, the polarity of the particle is controlled by the electric charge controlling agent, which exists in the particle as well as at the surface of the particle. As a result, the electrification amount of the electrophoretic particle is insufficiently controlled, and therefore, the particle cannot sufficiently respond to the applied voltage. Consequently, it is not possible to manufacture an electrophoretic display device having high reliability and durability.

### SUMMARY OF THE INVENTION

Accordingly, the present invention is directed to a collision electrification particle, an electronic paper display device using the same and a manufacturing method thereof that substantially obviate one or more problems due to limitations and disadvantages of the related art.

An object of the present invention is to provide a collision electrification particle having an electrified particle stabilizing agent coated at the outside of a polymer resin in a spherical shape, an electronic paper display device using the same and a manufacturing method thereof.

Another object of the present invention is to provide a collision electrification particle, the polarity of which can be finely controlled without an additional electric charge controlling agent, an electronic paper display device using the same and a manufacturing method thereof.

Yet another object of the present invention is to provide a collision electrification particle having high retentiveness and reliability, an electronic paper display device using the same and a manufacturing method thereof.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a collision electrification particle includes polymer resin and an electrified particle stabilizing agent coated at the outside of the polymer resin. That is, the amount and the electrification magnitude of the particle stabilizing agent are controlled using the electrified particle stabilizing agent without an additional electric charge controlling agent, whereby it is possible to control the polarity of the particle while securing the mobility of the particle.

Specifically, when a particle stabilizing agent electrified with (−) is coated at the outside of the polymer resin in a spherical shape, it is possible to obtain a collision electrification electronic paper particle having (−) polarity. When a particle stabilizing agent electrified with (+) is coated at the outside of the polymer resin in a spherical shape, on the other hand, it is possible to obtain a collision electrification electronic paper particle having (+) polarity.

In addition, when one particle is coated by a particle stabilizing agent electrified with (+) and a particle stabilizing agent electrified with (−), it is possible to change the polarity of the particle depending upon the amounts of the two particle stabilizing agents. Specifically, when particle stabilizing agents electrified with (+) and (−) are coated at the outside of the polymer resin in a spherical shape, and the amount of the particle stabilizing agent electrified with (−) is greater than that of the particle stabilizing agents electrified with (+), it is possible to obtain a collision electrification electronic paper particle having (−) polarity. When the amount of the particle stabilizing agent electrified with (+) is greater than that of the particle stabilizing agents electrified with (−), on the other hand, it is possible to obtain a collision electrification electronic paper particle having (+) polarity.

In another aspect of the present invention, an electronic paper display device includes a pair of substrates, at least one of which is transparent, the substrates being opposite to each other, barrier ribs disposed between the substrates while being spaced apart from each other, a plurality of particles encapsulated between the barrier ribs, the particles being coated with an electrified particle stabilizing agent, and a control unit to drive the particles.

In yet another aspect of the present invention, a manufacturing method of an electronic paper display device includes forming a pair of transparent electrodes on a pair of substrates, which are opposite to each other and at least one of which is transparent, forming barrier ribs between the substrates such that the barrier ribs are spaced apart from each other, and encapsulating a plurality of particles coated with a particle stabilizing agent between the barrier ribs.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a sectional view illustrating a cell structure of a general collision electrification electronic paper display device;

FIG. 2 is a typical view illustrating a general collision electrification particle including polymer resin, in which an electric charge controlling agent is contained;

FIG. 3 is a typical view illustrating a collision electrification particle according to the present invention, which includes polymer resin coated with a particle stabilizing agent;

FIG. 4 is a sectional view illustrating a cell structure of an electronic paper display device using the collision electrification particle according to the present invention; and

FIG. 5 is a flow chart schematically illustrating a manufacturing method of an electronic paper display device using a collision electrification particle according to the present invention.

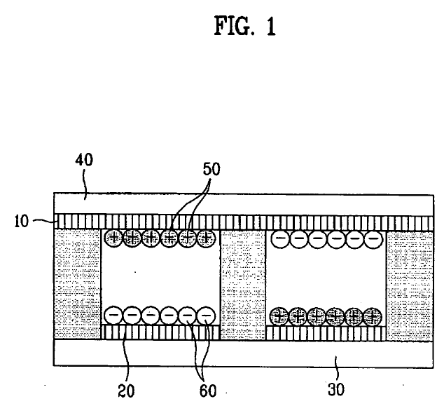

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

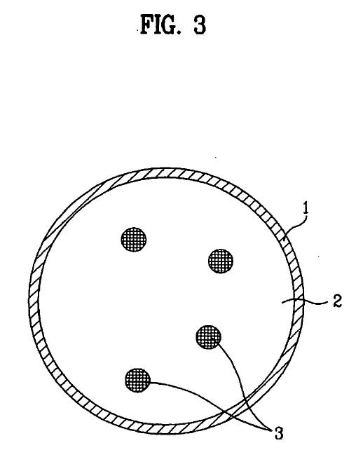

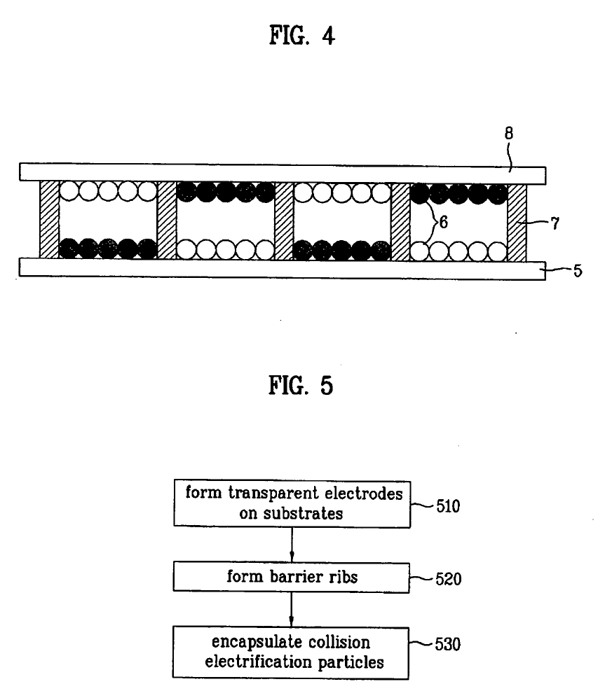

FIG. 3 is a typical view illustrating a collision electrification particle according to the present invention, which includes polymer resin coated with a particle stabilizing agent, and FIG. 4 is a sectional view illustrating a cell structure of an electronic paper display device using the collision electrification particle according to the present invention.

The present invention uses polymer resin containing no electric charge controlling agent. This polymer resin can be charged with electric charges or obtain electric charges. On the surface of the polymer resin is formed an electrified particle stabilizing agent. As shown in FIG. 3, polymer resin 2 is coated with a particle stabilizing agent 1 without an electric charge controlling agent according to the present invention. In the polymer resin 2 may be contained a dyed pigment or a dye 3.

The present invention provides a collision electrification particle. Specifically, the present invention provides a particle characterized in that an electrified particle stabilizing agent 1 without an additional electric charge controlling agent, and the polarity of the particle is controlled, while the mobility of the particle is secured, by controlling the amount of the particle stabilizing agent and the magnitude of electrification. More specifically, the particle according to the present invention is a collision electrification particle in which the electrified particle stabilizing agent 1 is coated over the outer surface of the polymer resin 2, which is formed in a spherical shape, whereby the collision electrification particle has a polarity.

The collision electrification electronic paper particle is used in an electronic paper display device. In such a collision electrification electronic paper display device, when sufficient voltage is applied to upper and lower electrodes, particles electrified according to the polarities of the electrodes move to the corresponding electrodes. Consequently, the particles according to the present invention must have polarities electrified with (+) or (−). In the collision electrification electronic paper display device, one of two particles having different colors in each cell is electrified with the positive, whereas the other particle is electrified with the negative.

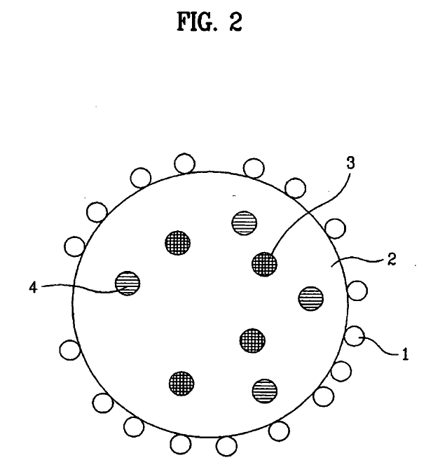

Up to now, the magnitude of the electrification amount and the polarities have been controlled based on the amount and the kind of an electric charge controlling agent added in a polymer particle at the time of manufacturing the polymer particle. The conventional collision electrification electronic paper particle is constructed in a structure in which the electric charge controlling agent is contained in the polymer resin. Furthermore, an outer additive agent, i.e., a particle stabilizing agent, and a pigment or a dye, which displays color of the particle, may be further contained in the polymer resin in order to increase the mobility of the particle (see FIG. 2). However, the electric charge controlling agent is located in the particle as well as at the surface of the particle. Even though the electric charge controlling agent is located at the surface of the particle, the electric charge controlling agent exists in bundles. As a result, the added electric charge controlling agent and the magnitude of the electrification amount are not proportional to each other, and therefore, it is very difficult to control the electrification amount.

The inventors of the present application have found that it is possible to accurately and easily control the electrification amount of the particle using the magnitude of the electrification amount and the polarities of the particle stabilizing agent coated on the outer surface of the particle. In this case, no electric charge controlling agent is contained in the particle, and therefore, it is possible to easily perform a particle manufacturing process and increase the yield rate of the particle. In the conventional particle, the electric charged controlling agent is contained in the particle before the particle is coated with the particle stabilizing agent. Consequently, it is possible to classify the particle as a (+) electrification particle or a (−) electrification particle. In the particle according to the present invention, on the other hand, the electric charged controlling agent is not contained in the particle. As a result, it is impossible to classify the particle as a (+) particle or a (−) particle until the particle is coated with the particle stabilizing agent. After the particle is coated with an electrified particle stabilizing agent according to the present invention, the particle can be classified as the (+) particle or the (−) particle. Consequently, the polarity of the particle fully depends on the polarity of the particle stabilizing agent.

Specifically, when a particle stabilizing agent electrified with (−) is coated on the outer surface of the polymer resin in a spherical shape, it is possible to obtain a collision electrification electronic paper particle having (−) polarity. When a particle stabilizing agent electrified with (+) is coated on the outer surface of the polymer resin in a spherical shape, on the other hand, it is possible to obtain a collision electrification electronic paper particle having (+) polarity.

The present invention is also characterized in that, when one particle is coated by a particle stabilizing agent electrified with (+) and a particle stabilizing agent electrified with (−), it is possible to change the polarity of the particle depending upon the amounts of the two particle stabilizing agents. Specifically, when particle stabilizing agents electrified with (+) and (−) are coated on the outer surface of the polymer resin in a spherical shape, and the amount of the particle stabilizing agent electrified with (−) is greater than that of the particle stabilizing agents electrified with (+), it is possible to obtain a collision electrification electronic paper particle having (−) polarity. When the amount of the particle stabilizing agent electrified with (+) is greater than that of the particle stabilizing agents electrified with (−), on the other hand, it is possible to obtain a collision electrification electronic paper particle having (+) polarity.

In other words, when the percentage of the particle stabilizing agents electrified with (+) is 50%, and the percentage of the particle stabilizing agents electrified with (−) is 50%, the particle has no polarity. When the amount of the particle stabilizing agents electrified with (+) is greater than that of the particle stabilizing agents electrified with (−), the particle has (+) polarity. This method is advantageous in that it is possible finely control the electrification amount of the particle by controlling the amount of the electrified particle stabilizing agent.

According to the present invention with the above-stated construction, it is possible to accurately and easily control the electrification amount of the particle using the magnitude of the amount or the polarity of the particle stabilizing agent coated on the outer surface of the particle. In addition, no electric charge controlling agent is contained in the particle at the time of manufacturing the particle. Consequently, the particle size distribution is small, and the control of the electrification amount is performed on the outer surfaces of two rubbed particles with the result that the electrification speed is high. Furthermore, a nano-sized particle stabilizing agent is uniformly coated on the outer surface of the particle according to the present invention. Consequently, the electrification amounts of the particles are constant, and the mobility of the particle is secured by the particle stabilizing agent, like the conventional particle. Preferably, the size of the particle stabilizing agent is approximately 100 to 1500 nm.

Another characteristic of the present invention is that the electrified particle stabilizing agent, included in the collision electrification electronic paper particle, preferably has an electrification amount of −800 μC/g to +400 μC/g. The present invention is characterized in that the electrification magnitude of the particle is controlled using the electrified particle stabilizing agent without an additional electric charge controlling agent. Consequently, the electrification amount of the electrified particle stabilizing agent is not particularly restricted, and any particle stabilizing agent having (+) electrification amount or (−) electrification amount is included in the scope of the present invention.

Preferably, the particle stabilizing agent electrified with (+) has an electrification amount of 0 μC/g to 400 μC/g, and the particle stabilizing agent electrified with (−) has an electrification amount of −800 μC/g to 0 μC/g. More preferably, the particle stabilizing agent electrified with (+) has an electrification amount of 0 μC/g to 200 μC/g, and the particle stabilizing agent electrified with (−) has an electrification amount of −400 μC/g to 0 μC/g. According to the present invention, when the particle stabilizing agent has larger (+) or (−) electrification amount, the same effect as when the amount of the electric charge controlling amount is large is obtained.

As described above, the present invention provides a collision electrification electronic paper particle. The polymer resin used in the present invention can be charged with electric charges or obtain electric charges. On the surface of the polymer resin is coated an electrified particle stabilizing agent, and a dyed pigment or a dye may be contained in the polymer resin. Hereinafter, the polymer resin and the particle stabilizing agent constituting the collision electrification electronic paper particle according to the present invention will be described in more detail.

First, an electrophoretic polymer resin containing no additional electric charge controlling agent will be described as the polymer resin usable in the present invention. A dyed pigment or a dye may be contained in the polymer resin. The selection of particles to be used in the electrophoretic electronic paper is very flexible. Preferably, the polymer resin used to accomplish the purpose of the present invention may be charged with electric charges or obtain electric charges (i.e., the polymer resin may have or obtain the electrophoretic mobility). The particles may be pure pigments, dyed (laked) pigments, pigment/polymer compounds, or other components that can be charged with electric charges or obtain electric charges. The typical consideration of the electrophoretic electrification particle is the optical and electrical properties of the electrophoretic electrification particle and the chemical properties of the surface of the electrophoretic electrification particle. The polymer resin according to the present invention may be organic or inorganic compound. Also, the polymer resin may absorb or scatter light.

A scattering pigment, an absorbing pigment, and a light-emitting particle may be also used as the particle used in the present invention. The particle may have reverse reflexibility, as in a corner cube, electroluminescence, as in a zinc-sulfide particle that emits light when it is excited by an AC field, or photoluminescence.

Specifically, titanium dioxide, zinc oxide, zinc sulfide, white lead, chrome yellow, cadmium sulfide, graphite, and carbon black are used for the polymer resin. The polymer resin may include, but is not limited to, polymethyl methacrylate (PMMA), polyethylene terephthalate (PET), polystyrene (PS), polyethylene, polypropylene, phenol resin, ethylene-vinyl acetate copolymer (Elvax resin—DuPont), polyester, polyacrylate, polymethacrylate, ethylene-acrylate or ethylene-methacrylate copolymer (Nucrel Resin—DuPont, Primacor Resin—Dow Chemical), acrylate copolymer, and terpolymer (Elvacite Resin—DuPont). Also, homopolymer having a high shear melting point and/or material useful in phase separation of pigment, as copolymer thereof, includes, but is not limited to, polyethylene, polypropylene, polymethyl methacrylate, polyisobutyl methacrylate, polystyrene, polybutadiene, polyisoprene, polyisobutylene, polylauryl methacrylate, polystearyl methacrylate, polyisobornyl methacrylate, poly-t-butyl methacrylate, polyethyl methacrylate, polymethyl acrylate, polyethyl acrylate, polyacrylonitrile, and copolymer of the above-specified two or more materials. More preferably, the polymer resin has a size of approximately 0.2 to 2.0 □.

The electrophoretic particle containing the dyed pigment or the dye generally may be a pigment, polymer, a laked pigment, or a combination thereof. The pure pigment may be arbitrarily selected. Generally, rutile (titania), anatase (titania), barium sulfate, kaolin, or zinc oxide is useful for light-colored particles. Some typical particles have high refractive index, high scattering coefficient, and low absorption coefficient. Other particles have absorptivity as in carbon black or color pigment used in paint or ink. Also, the pigment must be insoluble in a suspension fluid. Yellow pigments, for example, diaryl lead yellow, permanent yellow, and benzidine yellow, are also used in similar displays. Other reflective materials, including non-pigment materials such as metallic particles, may be used for light-colored particles.

Next, a particle stabilizing agent, which is different from the electric charge controlling agent, will be described in detail. The particle stabilizing agent is an outer additive agent coated on the polymer resin through condensation reaction. The particle stabilizing agent, which constitutes the collision electrification particle according to the present invention, serves to increase the mobility of the particle and to prevent the particle from being attached to the wall of a capsule. A non-aqueous surface active agent may be used for a typical liquid having high resistivity, which is used as a suspension fluid in an electrophoretic display. The respective components may be constructed from materials having wide molecular weight (low molecular weight, oligomerization, or polymerization). Alternatively, the respective components may be pure or mixtures. Any particle stabilizing agent from any related industry may be added to a non-aqueous medium in order to increase the electrophoretic mobility or to increase the electrostatic stabilization. Glycol ether, acetylene glycol, alkanolamide, sorbitol derivatives, alkylamine, quaternary amine, imidazoline, dialkyloxide, or sulphosuccinate may be used as the non-aqueous medium, which is not limited to above-specified medium. Preferably, nano-sized silica is suitable for the non-aqueous medium.

According to the present invention, the particle stabilizing agent serves as an outer additive agent to increase the mobility of the particle. Furthermore, the magnitude of the electrification amount and the polarity of the particle are selected by the electrified particle stabilizing agent, like the conventional electric charge controlling agent, whereby the electrification amount of the particle can be controlled. The particle stabilizing agent serves as an electrification controlling agent to improve the mobility of the particle. Consequently, the particle stabilizing agent may be ceramic powder, or natural or synthetic wax.

Specifically, the ceramic powder may be at least one selected from a group consisting of silicon dioxide (SiO₂), barium titanate (BaTiO₃), strontium titanate (SrTiO₃), calcium titanate (CaTiO₃), lead titanate (PbTiO₃), titanium dioxide (TiO₂), tin dioxide (SnO₂), calcium oxide (CaO), magnesium oxide (MgO), aluminum oxide (Al₂O₃), iron oxide (Fe₂O₃), gamma iron oxide, magnesium silicate (MgSiO₃), magnetite (Fe₃O₄), zirconium dioxide (ZrO₂), boric oxide (B₂O₃), silicon carbide (SiC), silicon nitride (Si₃N₄), nickel ferrite, zinc ferrite, nickel zinc ferrite, and barium ferrite (BaFe₂O₄). The natural or synthetic wax may be at least one selected from a group consisting of S-wax, polyethylene (PE) wax, ethylene-acrylate wax, ethylene-vinyl acetate, montan-based natural wax having carboxy acid partially connected to the terminal thereof, polyethylene-based synthetic wax, polypropylene-based synthetic wax, polymer wax, and synthetic wax having basic functional group, to the terminal of which amide or amine is partially connected.

The present invention also provides an electronic paper display device using the above-described collision electrification particle. According to the present invention, the collision electrification electronic paper display device includes a pair of substrates, at least one of which is transparent, the substrates being opposite to each other, barrier ribs disposed between the substrates while being spaced apart from each other, a plurality of particles encapsulated between the barrier ribs, the particles being coated with an electrified particle stabilizing agent, and a control unit to drive the particles.

FIG. 4 is a sectional view illustrating a cell structure of an electronic paper display device using the collision electrification particle according to the present invention. As shown in FIG. 4, the picture display device according to the present invention includes a transparent substrate 8, an opposite substrate 5, which is arranged opposite to the transparent substrate 8, electrification particles 6 located between the substrates while the electrification particles 6 are electrified with positive or negative charges, and barrier ribs 7 arranged such that the electrification particles 6 are encapsulated between the barrier ribs 7.

In the picture display device according to the present invention, the transparent substrate 8 is a substrate through which the color of the electrification particles 6 can be observed from the outside of the picture display device. Preferably, the transparent substrate 8 is made of a material having high transmissivity for visible rays and high thermal resistance. The flexibility of the electronic paper display device is appropriately selected according to its use. For example, a flexible material is suitable for the electronic paper according to the present invention. The substrate may be made of a polymer sheet, such as polyethylene terephthalate, polyethersulfone, polyethylene, or polycarbonate, or an inorganic sheet, such as glass or quartz. The substrate has a thickness of 2 to 5000 □, preferably, 5 to 1000 □. When the thickness of the substrate is too small, the strength of the substrate is decreased, and it is difficult to uniformly maintain the distance between the substrates. When the thickness of the substrate is too large, on the other hand, the resolution as the display function is decreased, and the contrast is lowered. Especially for the electronic paper, the flexibility is too low.

According to circumstances, electrodes may be formed at the substrates. When the electrodes are not formed at the substrates, electrostatic latent image is formed at the outer surfaces of the substrates, and colored fractional bodies, which are electrified with predetermined properties, are moved close to or away from the substrates by an electric field generated according to the electrostatic latent image, whereby the fractional bodies arranged in correspondence to the electrostatic latent image are observed through the transparent substrate from the outside of the display device. The formation of the electrostatic latent image may be accomplished by copying electrostatic latent image formed in a common electro-photograph system on the substrate of the picture display device according to the present invention using an electro-photograph photoconductor or directly forming electrostatic latent image on the substrate using ion flow. When the electrodes are formed at the substrates, on the other hand, colored fractional bodies, which are electrified with predetermined properties, are moved close to or away from the substrates by an electric field generated at the respective electrode positions on the substrates by applying external voltage to the electrodes, whereby the fractional bodies, which are arranged in correspondence to the electrostatic latent image, are observed through the transparent substrate from the outside of the display device. In this case, the electrodes are made of a conductive material which is transparent and can be patterned. For example, the electrodes may be made of metal, such as indium oxide or aluminum, or conductive polymer, such as polyaniline, polypyrrole, or polythiophene. Also, the electrodes may be formed by vacuum deposition or application. In addition, the thickness of the electrodes is not particularly restricted so long as the conductivity is secured and the light transmission is not obstructed. Preferably, the electrodes have a thickness of 3 to 1000 nm. More preferably, the electrodes have a thickness of 5 to 400 nm. In this case, the external voltage application may be performed using direct current or alternating current.

In the picture display device according to the present invention, it is preferable to form barrier ribs connecting the opposite substrates and construct display parts using a plurality of display cells such that the electrified particles cannot move in the direction parallel to the substrates. The shape of the barrier ribs is optimally formed based on the size of the fraction bodies. For example, the barrier ribs have a width of 10 to 1000 □, preferably, 10 to 500 □. Also, the barrier ribs have a height of 10 to 5000 □, preferably, 10 to 500 □. However, the width and the height of the barrier ribs are not limited to the above-specified sizes.

FIG. 5 is a flow chart schematically illustrating a manufacturing method of an electronic paper display device using a collision electrification particle according to the present invention. First, a pair of transparent electrodes are formed on a pair of substrates, which are opposite to each other and at least one of which is transparent (510). Subsequently, barrier ribs are formed between the substrates such that the barrier ribs are spaced apart from each other (520). At this time, ribs may be formed at both substrates, and then the barrier ribs may be joined to the ribs (a both-side rib method). Alternatively, ribs may be formed at one of the substrates, and then the barrier ribs may be joined to the ribs (a one-side rib method). In the picture display device according to the present invention, the one-side rib method is used to form the barrier ribs, whereby the deviation of the barrier ribs is prevented when the barrier ribs are joined to the substrates. Subsequently, a plurality of particles coated with a particle stabilizing agent are encapsulated between the barrier ribs (530). At this time, it is possible to control the polarity of the particles by controlling the coating amount or the electrification magnitude of the particle stabilizing agent.

As apparent from the above description, the polarity of the particle used in the conventional collision electrification electronic paper display device is controlled by an electric charge controlling agent located in the particle as well as at the outer surface of the particle. As a result, the electric charge controlling agent and the magnitude of the electrification amount are not proportional to each other, and therefore, it is very difficult to control the electrification amount. In the collision electrification particle according to the present invention, however, only an electrified particle stabilizing agent is used without an additional electric charge controlling agent. Consequently, it is possible to easily manufacture the electronic paper display device and to increase the yield rate thereof.

Also, it is possible to accurately and easily control the electrification amount of the particle using the magnitude of the amount and the polarity of the particle stabilizing agent coated on the outer surface of the particle. In addition, no electric charge controlling agent is included at the time of manufacturing the particle, and therefore, the particle size distribution is small, and the control of the electrification amount is performed on the outer surfaces of two rubbed particles with the result that the electrification speed is high. Furthermore, a nano-sized particle stabilizing agent is uniformly coated on the outer surface of the particle according to the present invention. Consequently, the electrification amounts of the particles are constant, and the mobility of the particle is secured by the particle stabilizing agent, like the conventional particle.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A collision electrification particle comprising:
polymer resin; and
an electrified particle stabilizing agent coated at the outside of the polymer resin.

2. The collision electrification particle according to claim 1, wherein the particle stabilizing agent has an electrification amount of −800 μC/g to +400 μC/g.

3. The collision electrification particle according to claim 1, wherein the polymer resin is at least one selected from a group consisting of polymethyl methacrylate (PMMA), polyethylene terephthalate (PET), polystyrene (PS), polyethylene, polypropylene, phenol resin, ethylene-vinyl acetate copolymer (Elvax resin—DuPont), polyester, polyacrylate, polymethacrylate, ethylene-acrylate or ethylene-methacrylate copolymer (Nucrel Resin—DuPont, Primacor Resin—Dow Chemical), acrylate copolymer, and terpolymer (Elvacite Resin—DuPont).

4. The collision electrification particle according to claim 1, further comprising:
a pigment or a dye.

5. The collision electrification particle according to claim 1, wherein the particle stabilizing agent is an electrification controlling agent to increase the mobility of the particle.

6. The collision electrification particle according to claim 1, wherein the particle stabilizing agent has a size of 100 to 1500 nm.

7. The collision electrification particle according to claim 1, wherein the particle stabilizing agent is ceramic powder, or natural or synthetic wax.

8. The collision electrification particle according to claim 7, wherein the ceramic powder is at least one selected from a group consisting of silicon dioxide (SiO₂), barium titanate (BaTiO₃), strontium titanate (SrTiO₃), calcium titanate (CaTiO₃), lead titanate (PbTiO₃), titanium dioxide (TiO₂), tin dioxide (SnO₂), calcium oxide (CaO), magnesium oxide (MgO), aluminum oxide (Al₂O₃), iron oxide (Fe₂O₃), gamma iron oxide, magnesium silicate (MgSiO₃), magnetite (Fe₃O₄), zirconium dioxide (ZrO₂), boric oxide (B₂O₃), silicon carbide (SiC), silicon nitride (Si₃N₄), nickel ferrite, zinc ferrite, nickel zinc ferrite, and barium ferrite (BaFe₂O₄).

9. The collision electrification particle according to claim 7, wherein the natural or synthetic wax is at least one selected from a group consisting of S-wax, polyethylene (PE) wax, ethylene-acrylate wax, ethylene-vinyl acetate, montan-based natural wax having carboxy acid partially connected to the terminal thereof, polyethylene-based synthetic wax, polypropylene-based synthetic wax, polymer wax, and synthetic wax having basic functional group, to the terminal of which amide or amine is partially connected.

10. An electronic paper display device comprising:
a pair of substrates, at least one of which is transparent, the pair of substrates being opposite to each other;
barrier ribs disposed between the pair of substrates while being spaced apart from each other;
a plurality of particles encapsulated between the barrier ribs, the particles being coated with an electrified particle stabilizing agent; and
a control unit to drive the particles.

11. The electronic paper display device according to claim 10, wherein the transparent substrate is made of any one selected from a group consisting of polyethylene terephthalate, polyethersulfone, polyethylene, polycarbonate, glass, and quartz.

12. The electronic paper display device according to claim 11, wherein the transparent substrate has a thickness of 2 to 5000 □ or 5 to 1000 □.

13. The electronic paper display device according to claim 10, wherein the control unit includes a pair of transparent electrodes, which are made of any one selected from a group consisting of indium oxide, aluminum, polyaniline, polypyrrole, and polythiophene.

14. The electronic paper display device according to claim 13, wherein the transparent electrodes have a thickness of 3 to 1000 nm or 5 to 400 nm.

15. The electronic paper display device according to claim 11, wherein the barrier ribs have a width of 10 to 1000 □ or 10 to 500 □ and a height of 10 to 5000 □ or 10 to 500 □.

16. A manufacturing method of an electronic paper display device, comprising:
forming a pair of transparent electrodes on a pair of substrates, which are opposite to each other and at least one of which is transparent;
forming barrier ribs between the substrates such that the barrier ribs are spaced apart from each other; and
encapsulating a plurality of particles coated with a particle stabilizing agent between the barrier ribs.

17. The manufacturing method according to claim 16, wherein the polarity of the particles is controlled by controlling the coating amount and the electrification magnitude of the particle stabilizing agent.

18. The manufacturing method according to claim 16, wherein the barrier ribs are formed using a one-side rib method, whereby the deviation of the barrier ribs is prevented when jointing the barrier ribs.
